(19) United States
(12) Patent Application Publication
(10) Pub. No.: US 2008/0307688 A1
(43) Pub. Date: Dec. 18, 2008

(54) Parking Facility

(76) Inventor: Bonnie Greenberg, Los Angeles, CA (US)

Correspondence Address: DARBY & DARBY P.C., P.O. BOX 770, Church Street Station, New York, NY, 10008-0770, US

(21) Appl. No.: 10/599,723

(22) PCT Filed: Apr. 5, 2005
(86) PCT No.: PCT/US2005/011476

§ 371 Date: Jul. 7, 2008

Related U.S. Application Data
(60) Provisional application No. 60/560,337, filed on Apr. 6, 2004.

(51) Int. Cl. G09F 3/14; E04H 6/00; G09F 1/00

(52) U.S. Cl. 40/664; 414/228; 40/673

(57) ABSTRACT

A parking facility which includes a multitude of parking spaces for individual cars containing a plurality of removable tickets at each parking space. Each ticket identifies its associated parking space so that an individual can park a car in one of the parking spaces and remove one of the tickets to help him or her locate the parking space at a later time. The tickets may be color coded to identify different regions of the parking facility, and, preferably, contain advertising and/or promotional material.

### CLAIM OF PRIORITY

This application claims the benefit of priority under 35 U.S.C. § 119 (e) to U.S. Provisional Application No. 60/560,337, filed Apr. 6, 2004, titled “Method for Identifying Cars in Parking Garage”, hereby incorporated by reference in its entirety.

The present invention relates to a parking facility which helps locate cars parked in a large garage.

It is customary today to build multi-level garages in which cars can be parked on many different levels over a wide area. Very often when a car is parked in such a garage, the owner of the car may have difficulty recalling where the car was parked when it is time to retrieve it. This problem can arise in many situations, even when the cars are parked on a single level, particularly where the area covered by the garage or parking lot is large, such as at an airport or the like.

The present invention provides a simple and convenient way for a car owner to locate a parked car regardless of the size of the garage or parking lot in which the car was left.

### THE DRAWING

FIG. 1 illustrates one floor of a multi-level indoor garage showing a number of parked cars in combination with the invention; and

FIG. 2 is an enlarged view of a ticket that can be used in accordance with the invention.

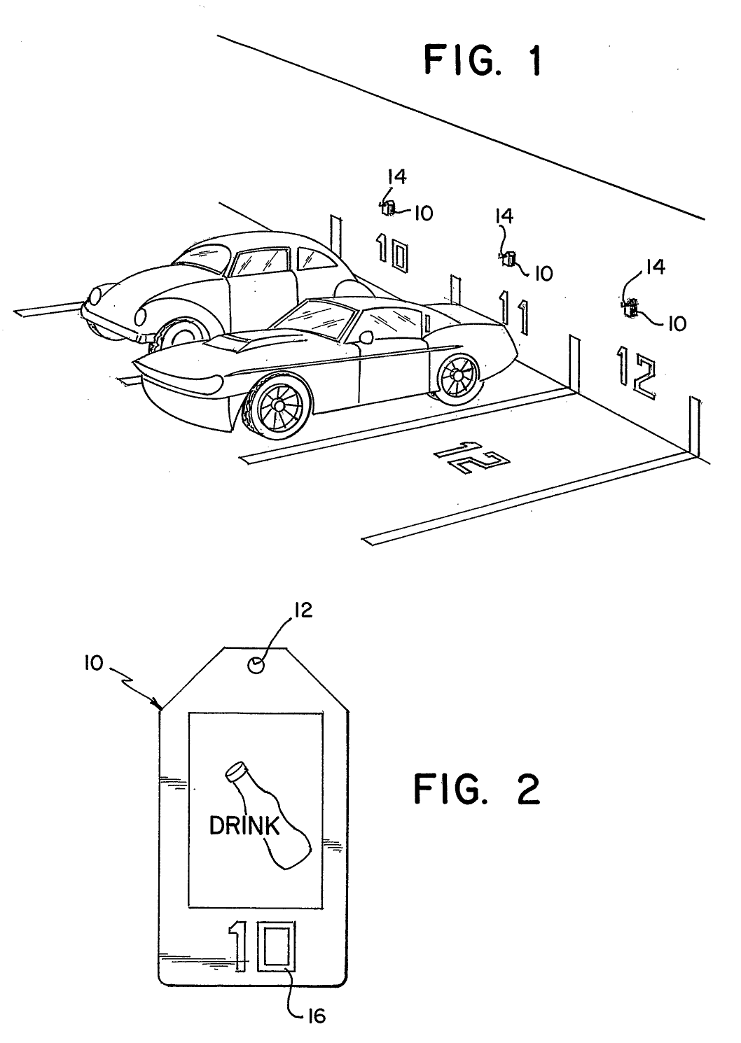

### DETAILED DESCRIPTION

In accordance with the invention, each space in a parking garage or parking lot includes a multiplicity of identical tickets 10 stored on a retention member 14.

A ticket that may be used in accordance with a preferred embodiment is shown enlarged on the right hand side of the drawing. It is preferably color coded and includes a hole 12 so that it can be easily stored and removed from retention member 14 which may be a simple hook. At the bottom of the ticket a designation 16 appears which identifies the parking space corresponding to the ticket. Typically, the parking space will be designated by row and position within the row, with the ticket color identifying the floor of the garage or the area of the parking lot. Obviously, there are many different ways in which the parking space can be identified in accordance with the invention.

As shown in the drawing, a multiplicity of individual tickets 10 are retained on the hook 14 at each parking space. When an individual parks his car in a particular space, he removes one of the tickets 10 from the hook 14 at that space. The ticket size is such that it can be conveniently carried by the individual and referred to later when it is time to retrieve the car. Since there are a multiplicity of cards at each parking space, it is not necessary that the car owner replace the ticket when he returns.

It is contemplated that the tickets will contain advertising or other promotional materials. Thus, from the perspective of the owner of the garage or parking lot, the cost of installing and maintaining the individual tickets at each of the parking spaces will be paid for by the advertisers. As an example, the ticket 10 shown in the drawing contains an advertisement for a Ford Explorer.

We claim:

1. A parking facility, comprising a multitude of parking spaces for individual cars, each of said parking spaces containing a plurality of removable tickets each of which identifies its associated parking space, whereby an individual can park a car in one of the parking spaces and remove one of the ticket at said one parking space to help him or her locate the parking space at a later time.

2. A parking facility according to claim 1, wherein the tickets are color coded to identify different regions of the parking facility.

3. A parking facility according to claim 1, wherein each ticket contains advertising and/or promotional material.

4. A parking facility according to claim 1, wherein retention means are located at each parking space for supporting the tickets associated with that space.

5. A parking facility according to claim 4, wherein said retention means comprises a hook and each of the parking tickets includes a hole for engaging the hook.
